(19) United States
(12) Patent Application Publication
(10) Pub. No.: US 2005/0143891 A1
(43) Pub. Date: Jun. 30, 2005

(54) Vehicle dynamics control system

(75) Inventor: Russell C. Smith, Albion, IN (US)

Correspondence Address: Dykema Gossett, Suite 300, 39577 Woodward Avenue, Bloomfield Hills, MI, 48304-2820, US

(73) Assignee: Dana Corporation, Toledo, OH (US)

(21) Appl. No.: 10/505,394

(22) PCT Filed: Feb. 21, 2003
(86) PCT No.: PCT/US03/05116

(51) Int. Cl. G06F 17/00

(52) U.S. Cl. 701/76

(57) ABSTRACT

A control system for a vehicle is provided that uses the frame of the vehicle as a sensory input to control various components of the vehicle. The control system includes one or more sensor assemblies that are mounted to the vehicle frame with each sensor assembly including one or more strain sensors generating signals indicative of the strain on the frame. The system further includes an electronic control unit that controls components such as the throttle valve, brakes, and warning indicators responsive to the signals generated by the strain sensors.

### BACKGROUND OF THE INVENTION

1. Field of the Invention

This invention relates to a control system for a vehicle and, in particular, to a control system that uses the vehicle frame as a sensory input in controlling various components of the vehicle.

2. Discussion of Related Art

As electronic control of vehicles continues to evolve, numerous electronic control systems have been and are being developed to control conventional mechanical components of the vehicle. Electronic throttle control, electronic fuel injection, tire pressure management, and ABS brakes are just a few of the many examples of the use of electronic control systems in vehicles. Many conventional control systems, however, are restricted by the response times generated from sensor inputs. Further, conventional control systems often require the use of relatively expensive sensors.

The inventors herein have recognized a need for a vehicle control system that will minimize and/or eliminate one or more of the above-identified deficiencies.

### SUMMARY OF THE INVENTION

The present invention provides a control system for a vehicle.

A control system in accordance with the present invention includes a plurality of sensor assemblies mounted on a frame of the vehicle. The sensors assemblies may be mounted in various locations on the frame of the vehicle and, in one embodiment, the sensor assemblies are mounted on the frame proximate each wheel of the vehicle and on front and rear cross members of the vehicle frame. Each of the sensor assemblies includes at least one strain sensor. The strain sensor generates a strain indicative signal indicative of strain on the vehicle frame. The control system further includes an electronic control unit (ECU). The ECU controls operation of a component of the vehicle responsive to the strain indicative signals generated by the strain sensors of the sensor assemblies. The vehicle component may, for example, comprise a throttle control valve or shock absorber.

A control system in accordance with the present invention represents a significant improvement as compared to conventional control systems. First, the use of the frame as a sensor substantially increases control response times of the control system. Second, the use of strain sensors provides a relatively inexpensive sensor arrangement. Third, the integration of the strain sensors and ECU into the vehicle structure will reduce assembly and inventory handling costs.

These and other advantages of this invention will become apparent to one skilled in the art from the following detailed description and the accompanying drawings illustrating features of this invention by way of example.

### BRIEF DESCRIPTION OF THE DRAWINGS

FIG. 1 is a perspective view of a portion of a vehicle incorporating a control system in accordance with the present invention.

FIGS. 2-4 are block diagrams illustrating power distribution and control in a control system in accordance with the present invention.

FIG. 5 is a block diagrams illustrating the interconnection of sensor assemblies and the electronic control unit of the inventive control system.

FIG. 6 is a block diagram illustrating a sensor assembly of the inventive control system.

FIG. 7 is a block diagram illustrating a control system in accordance with the present invention.

### DETAILED DESCRIPTION OF ONE OR MORE EMBODIMENTS OF THE INVENTION

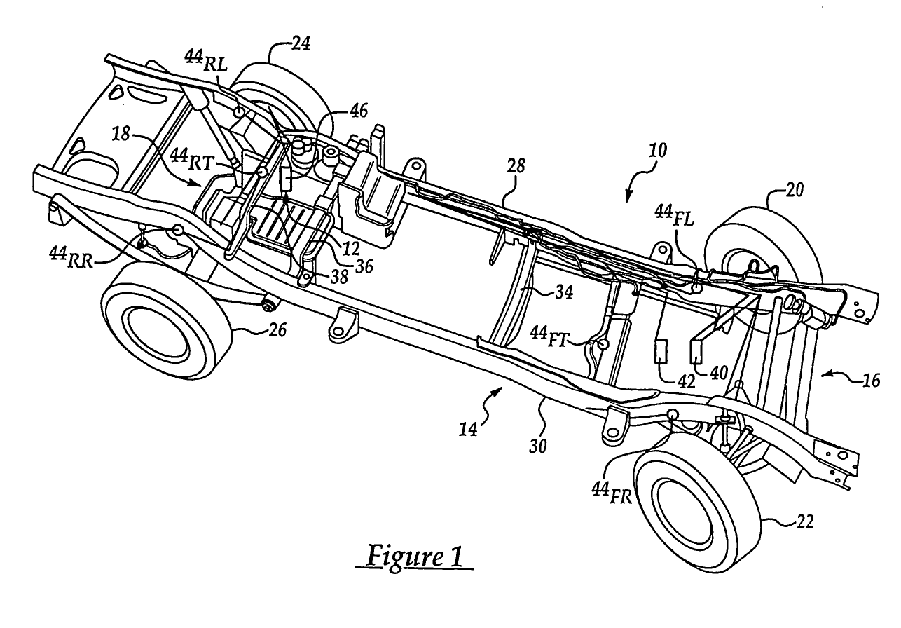

Referring now to the drawings wherein like reference numerals are used to identify identical components in the various views, FIG. 1 illustrates a portion of a vehicle 10 incorporating one embodiment of a control system 12 in accordance with the present invention. Vehicle 10 may comprise any of a wide variety of conventional vehicles including, but not limited to automobiles, light and heavy trucks, and off-road vehicles. Among other components, vehicle 10 may include a frame 14, axles 16, 18, and wheels 20,22,24,26.

Frame 14 is provided to support a conventional vehicle body on axles 16, 18. Frame 14 is conventional in the art and may be made from conventional metals and metal alloys. In the illustrated embodiment, frame 14 includes a pair of spaced longitudinal rails 28, 30 extending in the direction of vehicle travel and in the longitudinal direction of vehicle 10 and several cross-members 32, 34, 36, 38. It should be understood that the size, shape, and configuration of frame 14 will vary in accordance with various vehicle design parameters and the illustrated frame embodiment is not intended to limit the scope of the disclosed invention.

Rails 28, 30 are provided to secure and align the body (not shown) of vehicle 10 on frame 14 and are conventional in the art. The size, shape, and configuration of rails 28, 30 will vary depending upon design requirements associated with vehicle 10.

Cross-members 32, 34, 36, 38 are provided to connect rails 28, 30 and to support other components of vehicle 10 (e.g., the engine). Members 32, 34, 36, 38 are conventional in the art and it should again be understood that the number of cross-members as well as the size, shape, and configuration of cross-members, may vary depending upon design requirements associated with vehicle 10.

Axles 16, 18 are provided to rotatably support wheels 20, 22 and 24, 26, respectively, and to support other components of vehicle 10 such as suspension and brake system components. Axles 16, 18 are conventional in the art and may be forged or otherwise formed from a variety of conventional metals and metal alloys. In the illustrated embodiment, axle 16 comprises a steer axle, while axle 18 comprises a drive axle. Although the illustrated vehicle includes only two axles, it should be understood that the present invention may find use in vehicles having any number and type of axle.

Wheels 20, 22, 24, 26 are provided to mount the tires and are conventional in the art. Wheels 20, 22, 24, 26 are rotatably supported on axles 16, 18 in a conventional manner. For example, wheels 20, 22 may be supported on a spindle extending from a steering knuckle (not shown) that is coupled to axle 16 through a conventional kingpin connection (not shown). Wheels 24, 26 may be supported on axle half shafts (not shown) driven by a differential (not shown) and extending from the housing of drive axle 18. Wheels 22, 24, 26, 28 are also suspended from frame 14 by conventional suspension systems having components such as control arms, springs, and shock absorbers.

Control system 12 is provided to control one or more components of vehicle 10. The components controlled may include, for example, the throttle valve (not shown), shock absorbers (not shown) or other suspension components, a torsion bar coupled to frame 14, and brake systems (not shown). Control system 12 may also control components such as indicators that generate signals to the vehicle operator indicative of some characteristic of vehicle 10 such as tire pressure, balance, and shape, brake wear, vehicle load, and tongue weight. These indicators may be visual, audio, or a combination of the two, or may be designed to trigger other human senses (e.g., tactile senses through vibration). Control system 12 may include a power control assembly 40, communication interfaces 42, sensor assemblies 44_{FL}, 44_{FT}, 44_{FR}, 44_{RL}, 44_{RT}, and 44_{RR} (collectively and generically identified by the numeral 44 hereinafter) and an electronic control unit (ECU) 46.

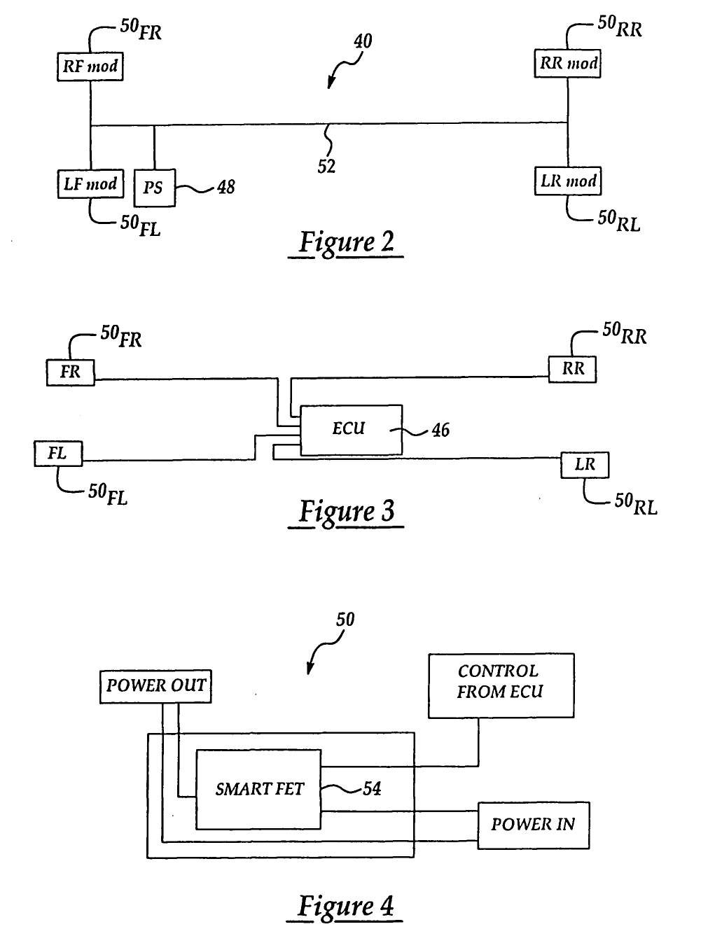

Power control assembly 40 is provided to distribute power to sensor assemblies 44. Referring to FIG. 2, assembly 40 may include a power supply 48 (such as a 12 volt or 42 volt battery), a plurality of power distribution modules 50_{FL}, 50_{FR}, 50_{RI}, and 50_{RR}, and a wiring harness 52 configured to distribute power from the power supply 48 to the power distribution modules 50 (collectively and generically identified by the numeral 44 hereinafter). Referring to FIGS. 3-4, each power distribution module 50 may include a conventional switching device 54 such as a smart field effect transistor that controls the flow of power from harness 52 to one or more sensor assemblies 44 responsive to a control signal from ECU 46. A current estimate of the power required for each power distribution module 50 is 1200 watts, but as much as 4000 watts may be required. Each sensor assembly 44 is expected to require between three (3) and eight (8) volts for proper operation.

Communication interface 42 is provided to interface ECU 46 with other electronic control units in vehicle 10. For example, ECU 46 may interface with the engine electronic control unit, the electronic control unit for the braking system, and the electronic control unit used to send and receive vehicle operator information. Interface 42 is conventional in the art and may include one or more wiring harnesses incorporating twisted pair cables as well as connectors at various termination points on the harness.

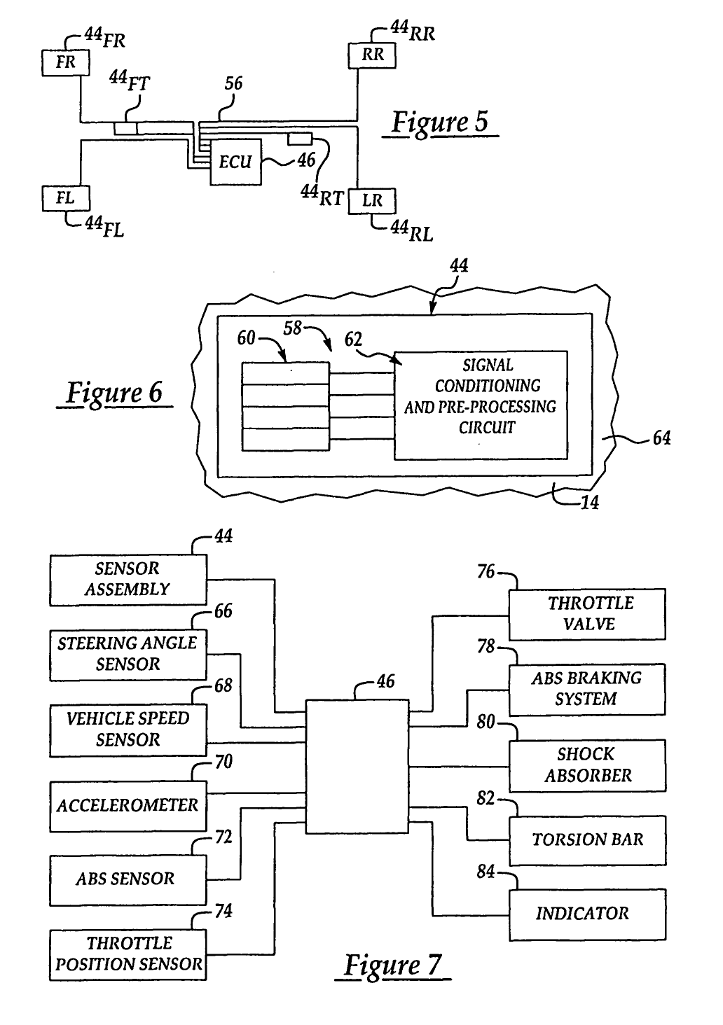

Sensor assemblies 44 are provided to transmit signals to ECU 46 indicative of the strain on frame 14 of vehicle 10. Referring to FIG. 1, assemblies 44 may be disposed in a variety of locations relative to frame 14. In one embodiment of the invention, sensor assemblies 44_{FL}, 44_{RL}, and 44_{FR}, 44_{RR} are disposed on rails 28 and 30, respectively, of frame 14, proximate each wheel 20, 22, 24, 26 of vehicle 10, and sensor assemblies 44_{FT}, 44_{RT}, are disposed on cross-members 32, 38 of frame 14. Referring to FIG. 5, a wiring harness 56 may be used to route signals between sensor assemblies 44 and ECU 46. The harness 56 may incorporate twisted pair cables. Referring now to FIG. 6, each sensor assembly 44 may include a sensor package 58 including a plurality of strain sensors 60 and an integrated electronics package 62, and means, such as mounting plate 64, for mounting assembly 44 to frame 14.

Strain sensors 60 are provided to indicate strain on areas of frame 14. Sensors 60 are conventional in the art may be formed from silicone using micro machining technology. In the illustrated embodiment, each sensor assembly 44 includes four strain sensors 60, although it will be understood that the number of strain sensors 60 may vary. The strain sensors 60 in each assembly 44 are redundant and bridged to provide common mode noise rejection. Sensors 60 generate strain indicative signals indicative of the strain on frame 14.

Package 62 is provided to condition and potentially process the strain indicative signals generated by sensors 60. Package 62 may include conventional circuitry for impedance matching, amplification, conditioning, summing, and analog to digital conversion. Package 62 may also include a digital signal processor for preprocessing signals prior to delivery to ECU 46.

Mounting plate 64 is provided to mount sensor assembly 44 to frame 14. Plate 64 may comprise a metal substrate to which sensor package 58 is bonded. Plate 64 may be coupled to frame 14 using conventional fasteners (not shown) or by welding.

Referring now to FIG. 7, ECU 46 is provided to generate control signals used to control one or more components of vehicle 10 responsive to the strain indicative signals generated by sensor assemblies 44. ECU 46 may comprise a programmable microprocessor or microcontroller or may comprise an application specific integrated circuit (ASIC). ECU 46 may include conventional components such as a central processing unit (CPU), an input/output (I/O) interface and memory. ECU 46 may be configured to process input signals and generate output signals used to control components of vehicle 10 by programming instructions or code (i.e. software). These instructions may be encoded on a computer storage medium such as a conventional diskette or CD-ROM and may be copied into the memory of ECU using conventional computing devices and methods.

ECU 46 receives inputs from each of sensor assemblies 44. In addition, ECU 46 may receive input signals from other conventional vehicle sensors and use these input signals together with the strain indicative signals to control components of vehicle 10. For example, ECU 10 may receive a steering angle indicative signal from a steering angle sensor 66, a speed indicative signal from a vehicle speed sensor 68, an acceleration indicative signal from an accelerometer 70, a brake signal from a wheel end ABS sensor 72, and a throttle position indicative signal from a throttle position sensor 74. Those of skill in the art will understand that signals generated by other conventional vehicle sensors may be input to ECU 46 as well for use in controlling components of vehicle 10.

ECU 46 generates one or more control signals used to control various components of vehicle 10. As set forth hereinabove, the components controlled by ECU 46 may include a throttle valve 76, ABS braking systems 78, shock absorbers 80 or other suspension components, a torsion bar 82, or various indicators 84 for the vehicle operator. Through control of such components, system 12 is able to exercise control over vehicle stability, rollover protection systems, ride height, and active suspension damping. The programming instructions or code for ECU 46 may be written in a modular format to enable potential customers to purchase controls for individual vehicle components (e.g., a shock absorber) or vehicle characteristics (e.g., rollover protection). The modular format is advantageous in allowing a manufacturer to offer for sale and manufacture vehicles having only those control features the customer wants.

A control system in accordance with the present invention represents a significant improvement as compared to conventional vehicle control systems. In particular, the inventive control system increases the response time for controlling various vehicle components from sensor inputs by integrating strain sensors into the vehicle frame and using the vehicle frame itself as a sensor. The inventive system also is relatively inexpensive. In particular, the use of strain sensors provides a less costly alternative to sensors more commonly used in vehicle control systems today. Further, the integration of the sensors into the vehicle frame will reduce assembly and inventory handling costs.

While the invention has been shown and described with reference to one or more particular embodiments thereof, it will be understood by those of skill in the art that various changes and modifications can be made without departing from the spirit and scope of the invention.

1. A control system for a vehicle, comprising:
a first sensor assembly mounted on a frame of said vehicle, said first sensor assembly including a first strain sensor generating a strain indicative signal indicative of strain on said frame; and,
an electronic control unit for controlling an operation of a component of said vehicle responsive to said strain indicative signal.

2. The control system of claim 1, further comprising a throttle position sensor that generates a throttle position indicative signal, said electronic control unit controlling operation of said component responsive to said strain indicative signals and said throttle position indicative signal.

3. The control system of claim 1, further comprising a steering angle sensor that generates a steering angle indicative signal, said electronic control unit controlling operation of said component responsive to said strain indicative signals and said steering angle indicative signal.

4. The control system of claim 1, further comprising an accelerometer that generates an acceleration indicative signal, said electronic control unit controlling operation of said component responsive to said strain indicative signals and said acceleration indicative signal.

5. The control system of claim 1, further comprising a vehicle speed sensor that generates a speed indicative signal, said electronic control unit controlling operation of said component responsive to said strain indicative signal and said speed indicative signal.

6. The control system of claim 1, further comprising a wheel end ABS sensor that generates a brake indicative signal, said electronic control unit controlling operation of said component responsive to said strain indicative signal and said brake indicative signal.

7. The control system of claim 1 wherein said component comprises a shock absorber.

8. The control system of claim 1 wherein said component comprises a torsion rod coupled to said frame.

9. The control system of claim 1 wherein said component comprises a wheel brake of said vehicle.

10. The control system of claim 1 wherein said component comprises a throttle valve.

11. The control system of claim 1 wherein said component comprises an indicator that provides an indication of a characteristic of said vehicle to an operator of said vehicle.

12. The control system of claim 16, wherein each of said first and second sensor assemblies is disposed proximate a different wheel of said vehicle on one of first and second longitudinal rails of said frame.

13. The control system of claim 1 wherein said first sensor assembly is disposed on a cross member of said frame between first and second longitudinal rails of said frame.

14. The control system of claim 1 wherein said first sensor assembly includes a second strain sensor generating a strain indicative signal indicative of strain on said frame.

15. The control system of claim 1 wherein said first sensor assembly includes a metal substrate coupled to said frame.

16. The control system of claim 1, further comprising a second sensor assembly mounted on said frame of said vehicle, said second sensor assembly including a first strain sensor generating a strain indicative signal indicative of strain on said frame
wherein said electronic control unit controls said operation of said component of said vehicle responsive to said strain indicative signals of said first and second sensor assemblies.
